(19) United States
(12) Patent Application Publication
(10) Pub. No.: US 2013/0233778 A1
(43) Pub. Date: Sep. 12, 2013

(54) Apparatus improvements for belt press dewatering

(71) Applicant: William H. Moss, Coral Springs, FL (US)

(72) Inventor: William H. Moss, Coral Springs, FL (US)

(73) Assignee: Mr. Willam H. Moss, Coral Springs, FL (US)

(21) Appl. No.: 13/385,796

(22) Filed: Mar. 8, 2012

(51) Int. Cl. B01D 33/052; B01D 33/056; B01D 33/46

(52) U.S. Cl. 210/91; 210/386; 210/145; 210/352

(57) ABSTRACT

Apparatus improvements to the method for improving belt press dewatering which incorporates a high compression zone with multiple pinch points. Apparatus improvements include a) separate lower permeable belts with different materials, weave patterns wrap and weft thread diameters and opening sizes for each pinch point; b) an apparatus for raising the upper frame for ease of replacing belts and automatic recovery from jamming of belt press; and c) independent gap width and compression adjustments at each pinch point.

### FIELD OF THE INVENTION

The present invention relates to the field of solids/liquid separation. More particularly, the invention relates to apparatus improvements related to the method for improving belt press dewatering described in U.S. Pat. No. 7,964,105 (Moss) and U.S. Pat. No. 7,381,329 (Moss).

### BACKGROUND OF THE INVENTION

Numerous examples of belt presses are provided in the prior art—for example, U.S. Pat. No. 7,381,329 (Moss), U.S. Pat. No. 6,454,102 (Thompson), U.S. Pat. No. 5,592,874 (Blauhut), U.S. Pat. No. 5,545,333 (Louden et al.) and U.S. Pat. No. 4,681,033 (Crandall et al.). In general, a belt press has a frame with an upper belt and a lower belt. Both upper and lower belts are typically liquid permeable [see U.S. Pat. No. 6,454,102 (Thompson), U.S. Pat. No. 5,592,874 (Blauhut), U.S. Pat. No. 5,545,333 (Louden et al.), U.S. Pat. No. 5,109,764 (Kappel et al.), U.S. Pat. No. 4,986,910 (Uyama et al.), U.S. Pat. No. 4,961,862 (Janecek), U.S. Pat. No. 4,879,034 (Bastgen), U.S. Pat. No. 4,836,100 (Johnson et al.), U.S. Pat. No. 4,681,033 (Crandall et al.), U.S. Pat. No. 4,181,616 (Bahr), U.S. Pat. No. 4,147,101 (Heissenberger et al.), and U.S. Pat. No. 3,942,433 (Wohlfarter)], although U.S. Pat. No. 5,022,989 (Put) suggests a non-permeable upper belt combined with a permeable lower belt is more advantageous. U.S. Pat. No. 4,986,910 (Uyama et al.) discusses the limitation of twin permeable filter fabrics for dewatering sludges.

Belt presses can employ several stages at which different techniques are used to remove the liquid from a mixture of solids and liquid. The use of these different stages improves filtering efficiency throughout the belt filter press.

In a typical belt press with multiple stages, the mixture initially enters a gravity screening zone of the belt press where free water drains through the lower permeable belt by gravity. The gravity screening zone is used primarily to remove free water. At the end of the gravity screening zone, the mixture could be near 10% solids. U.S. Pat. No. 6,454,102 (Thompson), U.S. Pat. No. 5,545,333 (Louden et. al.), U.S. Pat. No. 5,240,609 (Langley), U.S. Pat. No. 5,066,399 (Sugihara et al.), U.S. Pat. No. 5,022,989 (Put), U.S. Pat. No. 4,986,910 (Uyama et al.), U.S. Pat. No. 4,961,862 (Janecek), U.S. Pat. No. 4,836,100 (Johnson et al.) and U.S. Pat. No. 4,181,616 (Bahr) describe belt presses with gravity screening zones.

After the gravity screening zone, the mixture of solids and liquids enters the wedge zone where the upper belt and the lower belt carrying the mixture of solids and liquid converge with one another, applying progressively increasing pressure as the mixture is compressed between the belts. The degree to which the mixture is compressed corresponds to the angle of convergence of the belts, also called the wedge angle. The wedge angle may be fixed at all times or mechanically adjusted prior to running the filter press to accommodate a particular mixture. Wedge zones are shown in U.S. Pat. No. 7,381,329 (Moss), U.S. Pat. No. 6,454,102 (Thompson), U.S. Pat. No. 5,545,333 (Louden et al.), U.S. Pat. No. 5,240,609 (Langley), U.S. Pat. No. 5,109,764 (Kappel et. al), U.S. Pat. No. 5,066,399 (Sugihara et al.), U.S. Pat. No. 5,022,989 (Put), U.S. Pat. No. 4,986,910 (Uyama et al.), U.S. Pat. No. 4,961,862 (Janecek), U.S. Pat. No. 4,879,034 (Bastgen), U.S. Pat. No. 4,836,100 (Johnson et al.), 4,681,033 (Crandall et al.), U.S. Pat. No. 4,181,616 (Bahr), U.S. Pat. No. 4,053,419 (Pay), U.S. Pat. No. 3,942,433 (Wohlfarter), U.S. Pat. No. 3,894,486 (Sparowitz et al.) and U.S. Pat. No. 3,796,149 (Heissenberger).

Some belt presses have a higher pressure zone wherein the upper and lower belt follow a path between progressively smaller press rolls which may be either perforated or solid drums. The pressure imparted to the material between the upper and lower belts in the high pressure stage increases greatly from the largest perforated drum or solid roller to the smallest perforated drum or roller. High pressure zones are shown in U.S. Pat. No. 5,545,333 (Louden), U.S. Pat. No. 5,240,609 (Langley), U.S. Pat. No. 5,066,399 (Sugihara et. al), U.S. Pat. No. 4,986,910 (Uyama et al.), U.S. Pat. No. 4,879,034 (Bastgen), U.S. Pat. No. 4,836,100 (Johnson et al.), 4,681,033 (Crandall et al.), U.S. Pat. No. 4,181,616 (Bahr), U.S. Pat. No. 3,942,433 (Wohlfarter), and U.S. Pat. No. 3,796,149 (Heissenberger). Except for Uyama et al., each of these inventors teach us that gradually increasing compression pressure through the use of press rollers arranged in decreasing diameters in the direction of movement of the solids/liquid mixture corresponds to a progressive degree of liquid removal. Likewise, increasing shearing force through multiple changes in the direction of movement of the solids/liquid mixture by Z-shaped or S-shaped pathways also corresponds to a progressive degree of liquid removal.

The problem with all prior art is if the porous belt filter fabric becomes clogged or blinded, then liquid can not be separated from the solids/liquid mixture. In U.S. Pat. No. 4,986,910 (Uyama et al.), the inventors teach us that liquid in the solids/liquid mixture is removed only in the vertical direction through the filter fabric(s). To overcome the problem with blinding or clogging, the inventors formed pellets from pre-dehydrated sludge as an intermediate step prior to high compression pressing. The gaps between pellets that were then passed through the high compression zone provided a pathway for liquid to escape to the filter cloth and exit the solid/liquid mixture. The inventors claimed a higher removal rate of liquid in the high compression zone when forming pellets prior to high compression pressing

Another problem with the prior art practitioners whom rely on multiple press rollers of decreasing diameter and multiple changes of direction is described in U.S. Pat. No. 4,879,034 (Bastgen) who argues that pressure plates are superior to multiple press rollers because multiple press rollers have sections of reduced pressure between pinch points of multiple press rolls. Liquid that is pressed out in high compression zones at the pinch points will be sucked back into the solid/liquid mixture in low compression zones between the pinch points.

Another disadvantage of belt presses is that their mechanical design is complex, and maintenance and repair is time-consuming and costly. U.S. Pat. No. 4,584,396 (Crandall et al.) describes a frame design to minimize time and effort to replace belts, particularly endless belts which require a special frame that can be separated or disassembled. U.S. Pat. No. 4,971,691 (Meylor and Finn) describes a belt press design that is easy to assemble and re-assemble for cleaning and replacement of worn parts.

### SUMMARY OF THE INVENTION

The object of U.S. Pat. No. 7,964,105 (Moss) was to provide a method for improving all belt press designs by either adding or enhancing the high compression zone using a superior method, the net result being to produce press cakes with higher solids content and less liquid. The object of this invention is to provide apparatus improvements to designs that implement enhanced high compression zones using multiple pinch points wherein material being deliquified is:
a) pressed through a series of two or more additional pinch points formed by passing material to be deliquified on a lower permeable belt through the space between an upper roller and lower roller;
b) scraped;
c) separated from the lower permeable belt;
d) allowed to fall by gravity onto another lower permeable belt; and
e) re-arranged and repacked prior to passing through another pinch point
   In the '105 patent, the independent high compression zone may have a lower permeable belt that is different in material, fabric weave pattern, warp and weft thread diameters, opening size, and/or percent of open area than the lower permeable belt in the gravity screening zone and wedge zone.

In this invention, each combination of pinch point roller and return roller(s) may have a separate, lower permeable belt that is different in material, fabric weave pattern, warp and weft thread diameters, opening size, and/or percent of open area than the lower permeable belt in any other combination of pinch point roller and return roller(s). The purpose of having different, individual lower permeable belts for each pinch point is to optimize deliquifying for each pinch point and to lower the replacement cost of belts when the rate of wear and frequency of replacement is different for different sections of the high compression zone.

In a further preferred embodiment, hydraulic cylinders at each corner of the rectangular frame provide a mechanical means to lift the upper frame to provide space for ease of replacement of individual lower permeable belts. The hydraulic cylinders can also provide means for automatic recovery from jamming of the belt press by a foreign object that becomes permanently lodged in the wedge zone or between one of the pinch points. Foreign objects can become lodged in the wedge zone or between the small gap between pinch point rollers so as to obstruct and halt the operation of the moving belts. A magnetic detector, shaft rotational motion detector, or other shaft rotational counter can detect whether the rate of rotation of individual rollers has slowed or stopped, allowing an electronic or digital controller to automatically power the hydraulic cylinders to raise the upper frame so that the foreign object can pass between the pinch points without need for human intervention to raise the upper frame, remove or dislodge the foreign object, lower the upper frame, and return the belt press to normal operation.

In the '329 patent, four screw-and-bolt assemblies and springs were used to adjust the spacing and compression pressure between the upper non-permeable belt and the lower permeable belt at each corner of the rectangular upper assembly and lower assembly. In the '105 patent, separate screw-and-bolt assemblies and springs at the axial bearing rod of each upper roller and lower-belt roller pair were used to adjust the spacing and compression at each pinch point independently in the higher compression zone. Independent adjustment of the gap width and compression force between the upper and lower rollers is essential in deliquifying polymer-conditioned organic sludges. Very wet sludges need larger gap widths and lower compression forces to prevent gelatinous sludges from being forced into the openings of the permeable lower belt and preventing the permeable belt from separating liquid from solids. As the sludges become more deliquified, the gap widths need to be reduced and the compression pressures need to be increased to accomplish greater levels of deliquifying.

In a further preferred embodiment, an apparatus implementation of the independent gap width and compression adjustment is provided. The purpose of this design is to increase stability for long shafts used in wider belt presses so that high torques produced by higher mass flowrates will not deform the structural bearing rods of each roller.

### BRIEF DESCRIPTION OF THE DRAWINGS

FIG. 1 is a cross-sectional view of the '105 patent with a single, lower permeable belt

FIG. 2 is a cross-section of the belt press with separate, individual, lower permeable belts for each combination of pinch point roller and return roller(s)

FIG. 3A is a cross-section of the belt press showing hydraulic cylinders in the down position and FIG. 3B is a cross-section of the belt press showing hydraulic cylinders in the up position.

FIG. 4 is a detail showing the mechanism for adjusting the pinch point gap width and compression pressure independently for a single pinch point.

### DESCRIPTION OF THE PREFERRED EMBODIMENTS

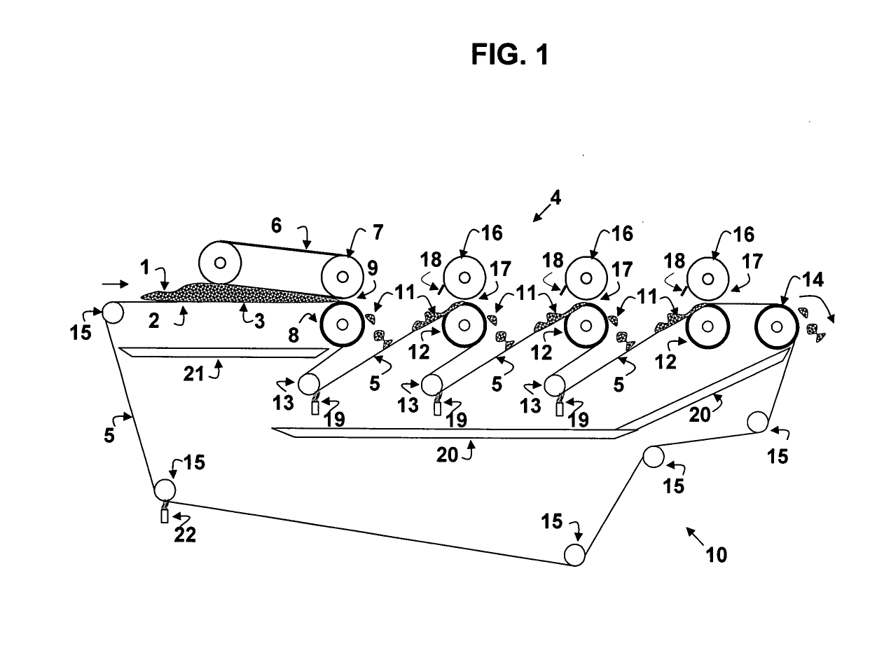

The subject of the invention are apparatus improvements to the method for removal of liquid from the press cake in the high compression zone of a belt press which was previously described in U.S. Pat. No. 7,964,105 (Moss) and depicted in FIG. 1. The belt press (10) that is used for the separation of a mixture of solids and liquids (1) consists of a gravity screening zone (2), a wedge zone (3), and a high compression zone (4). In the gravity screening zone, liquid is allowed to drain through the lower permeable belt (5) without pressure being applied by the upper belt. The wedge zone follows the gravity screening zone wherein the spacing between the lower permeable belt and the upper non-permeable belt (6) becomes increasingly narrow, causing pressure applied by the upper non-permeable belt to increase as the spacing between the belts decreases. At the end of the wedge zone, the upper belt roller (7) and the lower belt roller (8) form a pinch point (9) where the compression pressure is highest prior to the discharge of press cake (11) from the wedge zone. In the high compression zone, the lower belt is formed into a wavelike or S-shaped path by a series of two or more lower-belt pinch point press rollers (12) and companion backward return rollers (13) that shape the wavelike or S-shaped path. After the series of two or more multiple pinch point press rolls, the lower belt path is formed by a discharge roller (14) and multiple lower belt pick-up rolls (15) which maintain tension on the lower belt and form the pathway for a continuous lower belt. The high compression zone consists of a single, permeable lower belt. Instead of an upper belt, there are a series of two or more upper rollers (16) that create pinch points (17) with the lower belt and lower-belt pinch point rollers (12). The upper rollers are mounted close to the lower-belt pinch point rollers to create the pinch point. Any press cake material that adheres to the upper roller is scraped off by individual upper roller scrapers (18) that are positioned on the back side of the upper roller. The center of each backward return roller (13) in the wavelike or S-shaped path for the lower belt is positioned so that the press cake (11) is scraped off the lower belt (5); allowed to separate from the belt; and fall by gravity back onto the lower belt prior to the next pinch point, said separation and fall by gravity allowing the material to re-arrange and repack prior to passing through the next pinch point. Brushes (19) wipe the underside surface of the lower belt after each backward return roller (13) and before material scraped off the lower belt falls by gravity onto said lower belt; wherein said brushes break the surface tension between liquid and the belt allowing liquid to separate from the fabric, providing for a drier fabric to adsorb additional liquid from the press cake material that falls by gravity back onto the lower belt. Liquid that is brushed and separated from the lower belt falls by gravity into a liquid collection trough (20) which may be an extension of the liquid collection trough for the gravity screening zone and wedge zone (21), or alternatively, a separate, independent liquid collection trough. An additional brush (22) wipes the underside surface of the lower belt on the continuous return loop back to the gravity screening zone and wedge zone.

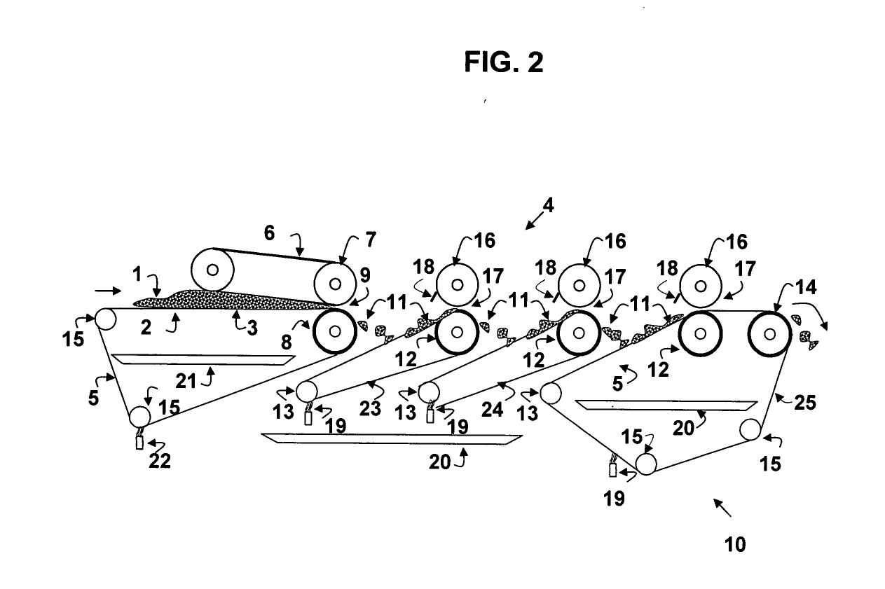

The subject of this invention is depicted in FIG. 2, wherein each combination of lower-belt pinch point roller (12) and companion backward return rollers (13) in the high compression zone that shape the wavelike or S-shaped path may have a separate, lower permeable belt (23, 24, or 25) that is different in material, fabric weave pattern, warp and weft thread diameters, opening size, and/or percent of open area from the lower belt (5) in the gravity screening zone (2) and wedge zone (3). Each belt in the high compression zone (23, 24 or 25) may be different in material, fabric weave pattern, warp and weft thread diameters, opening size, and/or percent of open area from the belts in other sections of the high compression zone. The purpose for different belts is to optimize deliquifying and lower the replacement cost of belts when the rate of wear and frequency of replacement is different for different sections of the high compression zone.

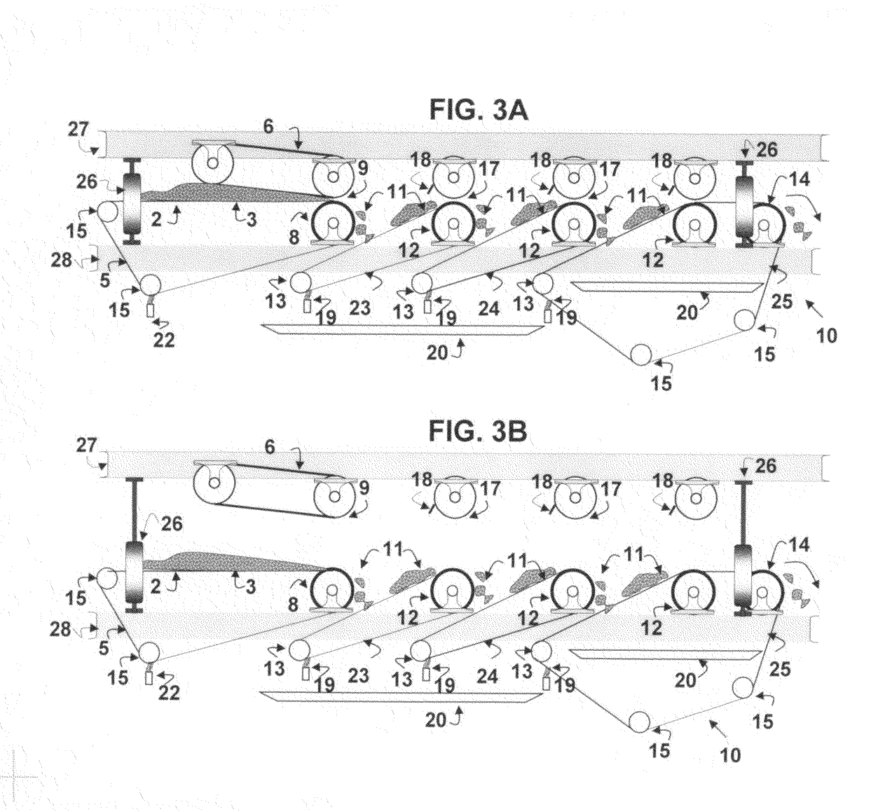

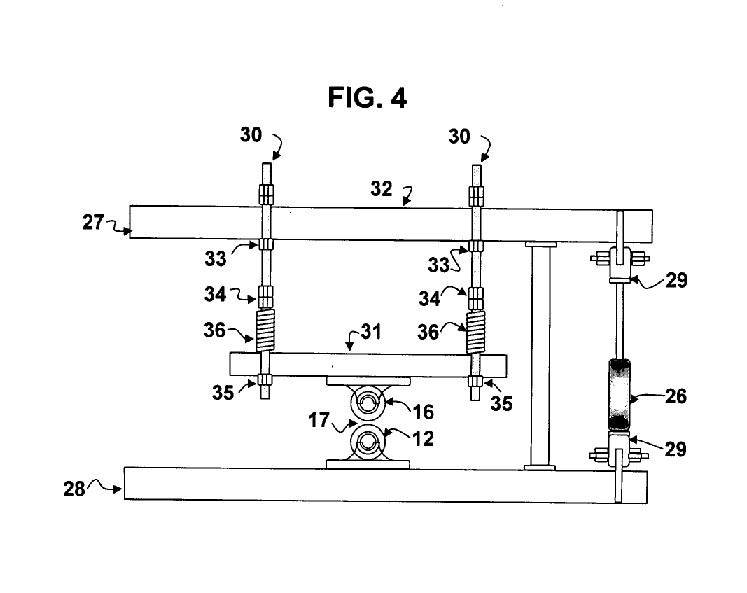

In a further preferred embodiment which is depicted in FIG. 3A, hydraulic cylinders (26) at each corner of the rectangular frame provide a mechanical means to lift the upper frame (27) above the lower frame (28). The upper frame is shown in the “down” position in FIG. 3A and in the “up” position in FIG. 3B. The hydraulic cylinders are attached to the upper frame and lower frame with connector assemblies (29) as depicted in FIG. 4. The hydraulic cylinders provide a mechanical means to lift the upper frame to provide space for ease of replacement of individual lower permeable belts. The hydraulic cylinders can also provide means for automatic recovery from jamming of the belt press by a foreign object that becomes permanently lodged in the wedge zone or between one of the pinch points. Foreign objects can become lodged in the wedge zone or between the small gap between pinch point rollers so as to obstruct and halt the operation of the moving belts. A magnetic detector, shaft rotational motion detector, or other shaft rotational counter can detect whether the rate of rotation of individual rollers has slowed or stopped, allowing an electronic or digital controller to automatically power the hydraulic cylinders to raise the upper frame so that the foreign object can pass between the pinch points without need for human intervention to raise the upper frame, remove or dislodge the foreign object, lower the upper frame, and return the belt press to normal operation.

In a further preferred embodiment which is depicted in FIG. 4, the gap width (17) is adjusted independently for each pinch point by two vertical threaded rods (30) which connect the upper roller bearing base (31) to the upper frame (27). Each vertical threaded rod (30) assembly is comprised of two top bolts (32), one upper-middle bolt (33), two lower-middle bolts (34), and one lower bolt (35). The gap width between upper roller and its respective lower-belt roller is adjusted by raising or lowering the lower bolts (35) on the vertical threaded rods (30). This apparatus makes it possible to independently increase or decrease the gap width at each pinch point. Each vertical threaded rod (30) is equidistant from the upper roller shaft, and the separation width between the two vertical threaded rods (30) is greater than the height of each mechanical separator vertical threaded rod (30) so that torques generated on the roller bearings do not deform the upper roller shaft.

In a further preferred embodiment, each pinch point gap width separator vertical threaded rod (30) may incorporate a spring compression assembly (36) so that an increase in the flow of press cake through the gap will increase the compression pressure in the pinch point. The compression force of the springs (30) at each pinch point can be adjusted independently by raising or lowering the position of the spring compression adjustment bolts (34) at each pinch point compression upper roller.

Independent adjustment of the gap width and spring compression force is essential in deliquifying polymer-conditioned organic sludges. Very wet sludges need larger gap widths and lower compression forces to prevent gelatinous sludges from being forced into the openings of the permeable lower belt and preventing the permeable belt from separating liquid from solids. As the sludges become more deliquified, the gap widths need to be reduced and the compression pressures need to be increased to accomplish greater levels of deliquifying.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

I claim:

1. A belt press apparatus for thickening and deliquifying a mixture of solids and liquids with a belt press having a gravity screening zone, a wedge zone to create pressure between the belts, and a high compression zone, said apparatus being comprised of:
(a) a single, lower permeable belt comprising a woven, plain weave synthetic material with openings ranging in size from 300 microns-by-300 microns square (U.S. Standard Sieve Size 50) to 2,000 microns-by-2,000 microns square (U.S. Standard Sieve Size 10) and open area ranging in size from 35-50% at 300 micron square openings to 50-55% at 1,000 micron square opening to allow solids to be retained and liquid to pass through the lower permeable belt;
(b) a rectangular upper assembly consisting of a rectangular frame, connected to the lower belt assembly by four screw and bolt assemblies at each corner of the rectangular frame;
(c) an upper non-permeable belt consisting of a synthetic material;
(d) a gravity screening zone of the belt filter press wherein a mixture of solids and liquids is allowed to drain through the lower permeable belt without pressure being applied by the upper belt;
(e) a wedge zone following the gravity screening zone where the spacing between the two belts becomes increasingly narrow as the mixture of solids and liquid is conveyed along the belt press, wherein the pressure applied by the upper non-permeable belt increases as the spacing between the belts decreases;
(f) a high compression zone comprising a series of two or more additional pinch points formed by passing material to be deliquified that is carried on the lower permeable belt through the space between an upper roller and lower roller;
(g) a wavelife or S-shaped path for the material being deliquified created by scraping deliquified press cake from the lower belt, allowing the press cake to separate from the lower belt and fall by gravity on to a section of the lower belt that has been wiped to separate liquid from the belt, allowing the material to re-arrange and repack on the lower belt prior to passing through the next pinch point, said lower belt passing over a pinch point roller and a return roller positioned behind its associated pinch point roller;
(h) a means for adjusting the spacing between the upper and lower roller at each pinch point, and
(i) a means for adjusting the compression pressure at each pinch point so that an increase in the flow of the mixture of solids and liquids will increase the compression at each pinch point.

2. The apparatus as recited in claim 1, wherein each combination of pinch point roller and return roller(s) in the high compression zone may have a separate, lower permeable belts that are different in material, fabric weave pattern, warp and weft thread diameters, opening size, and/or percent of open area to optimize deliquifying and lower the replacement cost of belts when the rate of wear and frequency of replacement is different for different sections of the high compression zone.

3. The apparatus as recited in claim 1, wherein hydraulic cylinders at each corner of the rectangular frame provide a mechanical means to lift the upper frame to:
(a) provide space for ease of replacement of individual lower permeable belts; and
(b) provide means for automatic recovery from jamming of the belt press by a foreign object that becomes permanently lodged in the wedge zone or between one of the pinch points so as to obstruct and halt the operation of the moving belts; wherein a magnetic detector or shaft rotational motion detector, or other shaft rotational counter detects that the rate of rotation of individual rollers has slowed or stopped; and an electronic or digital controller automatically powers the hydraulic cylinders to raise the upper frame so that the foreign object can pass between the pinch points without need for human intervention to raise the upper frame, remove or dislodge the foreign object, lower the upper frame, and return the belt press to normal operation.

4. The apparatus as recited in claim 1, wherein, the gap width at each pinch point between upper roller and lower belt pinch point roller is adjusted by two mechanical separator devices equidistant from the axial bearing rod of each upper roller and lower-belt roller pair, making it possible to independently increase or decrease the gap width at each pinch point, with the separation width between the two mechanical separator assemblies greater than the height of the mechanical separator so that torques generated on the roller bearings do not deform the upper roller shaft.

5. The apparatus as recited in claim 1, wherein each pinch point gap width separator incorporates an independent, adjustable spring compression assembly so that an increase in the flow of press cake through the gap will increase the compression pressure in the pinch point, said compression pressure being independently adjustable at each pinch point.
